(19) United States
(12) Patent Application Publication
(10) Pub. No.: US 2011/0294085 A1
(43) Pub. Date: Dec. 1, 2011

(54) Method and device for the temperature control and/or temperature regulation of a preform heating device

(75) Inventors: Klaus Voth, Obertraubling (DE); Konrad Senn, Regensburg (DE); Jochen Hirdina, Regensburg (DE); Helmut Asbrand, Regensburg (DE)

(73) Assignee: KRONES AG, Neutraubling (DE)

(21) Appl. No.: 13/068,918

(22) Filed: May 24, 2011

(30) Foreign Application Priority Data
May 25, 2010 (DE) DE 102010021445.0

(51) Int. Cl. F27D 19/00

(52) U.S. Cl. 432/31; 432/36

(57) ABSTRACT

A method for the temperature control and/or regulation of a heating device (10) for preforms (46) made from a thermoplastic material, the method being intended for controlling the temperature of the preforms (46) prior to a subsequent blow molding or stretch blow molding process. The temperature control process includes at least two distinct, consecutive heating stages (12, 14). At least one temperature reading of the preforms after the first heating stage is taken, and deviations of the at least one temperature reading from a specified set point temperature is determined, a first temperature reading of the at least one temperature reading being taken after the first heating stage. Radiators in the second heating stage are regulated or adjusted as a function of the first temperature reading and temperature deviations of the preforms from the specified set point temperature are compensated for prior to exit of the preforms from the heating device. The invention further includes a heating device for performing the method.

This claims the benefit of German Patent Application DE 10 2010 021 445.0, filed May 25, 2010 and hereby incorporated by reference herein.

The present invention relates to a method for the temperature control and/or temperature regulation of a preform heating device. The invention furthermore relates to a heating device for controlling the temperature of preforms.

### BACKGROUND

Beverage containers made from thermoplastic materials, especially from the most widely used PET, are commonly produced in a stretch blow molding process. In this mostly two-stage stretch blow molding process the containers are typically produced from injection-molded, rotationally symmetric preforms. The said preforms consist of an elongated, cylindrical, lateral body section with a rounded, closed bottom and a neck section with an upper opening, which can also be referred to as mouthpiece section. Positioned close to this opening there is usually a thread section, which can be delimited toward the bottom by a collar or the like. Already during the injection-molding process of the preform is the said thread section produced to final dimensions as will be required for later use. During the stretch blow molding process it continues to keep its original shape and later forms the thread for the screw cap of the finished beverage container. The remaining sections of the preform are, in contrast, deformed and stretched. During the manufacturing process the said preforms are heated to a predefined magnitude of process temperature in order to enable forming by stretch blow molding in the desired manner. The heating is mostly performed by means of infrared radiation, because in this manner it is possible to ensure defined and uniform temperature control of the preforms.

The plastic material intended for further processing (in general PET) is of such a nature that it will strain harden as it is stretched. Of decisive importance in this process is the forming temperature. The strain hardening effect is normally put to use in the production of PET containers for the purpose of controlling and optimizing wall thickness distribution. Depending on the production process, it is possible to apply the infrared radiation in such a way that the preforms are heated according to a temperature profile. The aim of this is to have the warmer sections deformed with priority to the other parts as long as is required for the stretching resistance resulting from strain hardening to become greater than the resistance of the adjacent cooler sections. Commonly, the temperature profile is uniformly distributed around the circumference of the preforms and can vary process-dependently along the longitudinal axis of said preforms.

In order to apply the desired temperature profile to the preforms it is possible to use a number of zones, for instance up to nine or more zones. It is possible to control this plurality of different zones individually, whereby the selected setting is maintained constant over a longer period of operating the heating apparatus. In order to respond to changes in the ambient conditions it is possible to use a regulating system for recording the preforms' temperature at at least one measuring point. This regulating system is intended for keeping the preforms' temperature at the selected measuring point constant. The controlled variable represents the manipulated input variable for all heating apparatuses so that in the instance of measuring a temperature that is below a pre-set nominal temperature, the manipulated variable and thus the heat output to all heating apparatuses will be increased.

In general, this regulating system is indispensable, as the preforms' temperatures may vary over time, for instance after a certain period of operation and with the heating apparatus gradually warming up. The production hall may also warm up during an operating day, for instance, possibly causing heat build-up to the heating apparatuses and the preforms. Although it may still be possible to influence and modify the different heating zones each proportionally to the same extent, modifying the manipulated variable too much, however, may result in the total heat increase to deviate more than desired because the entire heating profile may change. Temperatures deviating too much from a nominal temperature may have negative influences on container quality.

### SUMMARY OF THE INVENTION

In order to avoid these problems the various heating zone controls are, in practice, manually adjusted. In addition, it is also possible to have different programs to make allowances for temperature differences between summer and winter operation.

It is an object of the present invention to provide an improved method for the temperature control of preforms in connection with a stretch blow molding process, whereby the said preforms are heated according to a desired temperature profile with said temperature profile complying as exactly as possible to the nominal values, even under changing external conditions. A further alternate or additional aim of the invention is to provide an improved preform heating device which allows setting the temperatures and temperature profiles required for affecting the preforms as accurately as possible.

The present invention provides a method for controlling and/or regulating a heating device for preforms made from a thermoplastic material, especially from PET, whereby the method for controlling makes it possible to adjust the heating device in the desired manner for the purpose of bringing the preforms to the optimal temperature prior to a subsequent blow molding or stretch blow process. The temperature control process comprises at least two separate, consecutive heating stages, whereby each of the heating stages especially fulfills different tasks. Further heating stages can be provided to achieve an optimized tempering of the preforms according to a desired thermal profile. The first heating stage is intended for achieving a nearly uniform base temperature of at least parts of the preform. The first heating stage is especially intended for achieving a nearly uniform base temperature of the entire preform. The base temperature normally corresponds approximately to the maximum heating temperature for maintaining the dimensional stability of the thread section at the preform's open-topped neck section. If necessary the heating of the preforms to the basic temperature can also be done with a lower temperature. The main aim—which is the exact regulation of the heating process of bringing the preforms to the optimal temperature in the subsequent heating stages—remains. Hereby a reduced temperature gradient between consecutive heating stages is advantageous. The second heating stage can be used for further heating of the preforms to the required temperature; especially it is intended for achieving a temperature profile according to a predefined thermal profile. The temperature profile should reach the forming temperature required for blow molding or stretch blow molding at least for the preform's body section located below the thread section and/or a collar area located therebelow. The present invention provides an improved concept for thermal layering of the preforms. The preforms are first heated in a first heating stage to a basic temperature. After the first heating stage at least one temperature value of the preform is recorded. On the basis of the temperature values recorded after the first heating stage, the heat output of the second heating stage is adjusted accordingly. Deviations from a predefined set temperature value of at least one temperature recorded after the first heating stage are compensated by regulation of radiators of at least the second heating stage. Thereby temperature deviations can be compensated before the preforms leave the heating device.

Preferentially the temperatures of the radiators of the first heating stage and of the second heating stage are regulated simultaneously according to the recorded temperature values. It can be of further advantage if the temperature is recorded at several positions along the preform's longitudinal axis, whereby the radiators in the respective associated heights of the second heating stage are regulated accordingly. The temperature reading can for instance be done in a section of an infrared oven with a directional change. The temperature measurement can preferentially be done in a turnaround section of a linear infrared oven.

The temperature adjustment of the second heating stage is preferentially done depending on the average preform temperature. The average preform temperature is determined by averaging several temperature readings of successive preforms. In this way the oven temperature is “leveled off”. Hereby stronger regulatory adjustments can be avoided. The temperature adjustment achieved by this control of the oven shall “fit” all successively treated preforms and heat these preforms to the correct desired temperature.

The present invention can proceed from a largely conventional infrared oven. The temperature of at least a part of the oven or the entire heating devices can be controlled.

The heating is done in two or more heating stages. Depending on the temperature control of the oven, a more direct and more customized temperature control can be achieved in the individual heating stages. The heating is commonly achieved in at least two consecutive sections or heating stages of the heating device. The first section provides the preforms with basic heating in order to heat them to a base temperature that is as uniform as possible and that is below the softening temperature of the plastic material, in order to avoid, as far as possible, that the thread section is unduly heated. Thermal layering is not yet applied during this basic heating phase, as the intention is to achieve a uniform temperature distribution over the entire body of the preform. In this phase of tempering a uniform temperature distribution over the entire body of the preform is advantageous. For this purpose it is possible, if required, to use a suitable algorithm to predefine a zonal layering depending on the preform's geometry (wall thickness, distance to radiator, length). The regulation system in the method according to the invention is intended to achieve a defined base temperature, as far as possible throughout the process, whereby said base temperature can range between at least 50° C. and up to 90° C. In this manner the method allows to compensate for different input and storage conditions of the preforms. As the said preforms are likely to have been stored in different locations at different temperatures before being supplied to the stretch blow molding process, it is necessary to provide uniform input conditions for the preforms in order to achieve the best forming results possible. Accordingly, a basic heating phase constitutes the first temperature control stage and a subsequent temperature profiling phase constitutes the second temperature control stage. During the temperature profiling phase that constitutes the second section, the preforms are heated with the temperatures being variably layered, i.e. in direction of the longitudinal axis of the said preforms.

According to a preferred embodiment of the inventive method it is possible to provide at least one temperature reading at the exit of the first heating stage in order to record the preforms' temperature after the basic heating and to appropriately adjust the temperature of the first heating stage and/or all heating stages of the oven. An alternative and/or combination of this temperature control for the adjustment of the first heating stage comprises a temperature reading after the first heating stage, the temperature reading is especially taken in a middle part of the oven. The recording of the temperature can for instance be done with a known pyrometer measuring unit. All heating stages are regulated on the basis of this temperature reading. Especially the second heating stage and/or further heating stages are equally controlled and regulated. In this alternative embodiment of the oven control the temperature is recorded in the middle of the oven or after the first heating stage. On the basis of the recorded temperature values the whole oven is appropriately controlled and/or regulated to reduce the so called scrap rate. The scrap rate comprises all preforms that are heated to a temperature that is either too high or too low for the subsequent blow molding process. Wrongly tempered preforms lead to troubles in the subsequent blow molding process. For a method according to this embodiment it is not necessary to have different controls for the different heating stages. A common or joint regulation based on the temperature reading between the heating stages is sufficient for the control and/or regulation of all heating stages. Such a temperature correction or temperature regulation allows short term adjustment. Especially a short-term correction can be made when changes in the surrounding conditions occur during stand-by mode. In principle it is also possible to have several such regulations. For instance temperature values can be recorded after the first heating stage and after the second heating stage, especially if a third heating stage and/or further heating stages are present.

Optionally at least one further temperature reading after the second heating stage is provided. This second temperature reading records the final temperature of the preforms after the first heating stage and/or after the second heating stage or the thermal profiling phase. The measured temperature value is taken into consideration when adjusting the first heating stage. The temperature recorded after the first heating stage is at least taken into consideration when adjusting the thermal output of this first heating stage. In addition to the temperature recorded after the first heating stage or basic heating phase, the final temperature recorded after the second heating stage or temperature profiling phase is additionally used to regulate and adjust the first heating stage. It is also possible to use both temperatures values—the temperature recorded after the first heating stage and the final temperature recorded after the second heating stage—to regulate and adjust the thermal output of the first heating stage and/or to regulate and adjust the thermal output of the second heating stage.

Due to the regulated temperature in the basic heating phase, it can be assumed throughout that the preforms are in the same initial condition when they enter the temperature profiling phase. Ideally, temperature layering would not change afterwards so that the temperature or the heat output of the heating stages would require no readjustments, thus making a control loop unnecessary. The temperature should nevertheless be measured at the exit of the oven as well in order to be able to monitor the actual temperature of the preforms upon entry into the blow molding station and in order to compensate for side effects, such as aging to the heating devices, for instance to the infrared radiators. The measurement value acquired in this process can be used for accordingly adjusting the oven control's setting value for the basic heating process.

In an alternative embodiment it is further possible to use the value measured at the oven's exit for regulating and controlling the second heating stage, provided that this is necessary for reasons of the heating devices' aging or other side effects. Preferably, the measurement value taken after the first heating stage is additionally taken into account for regulating and controlling the second heating stage.

It is moreover advantageous for the preforms to be heated, in the section of the first heating stage or the basic heating phase, to a largely uniform base temperature ranging between approximately 50° C. and approximately 90° C. This temperature depends primarily on the maximum allowable temperature for the neck section of the preforms made from PET or another suited thermoplastic material, because this section with its thread that is to be used later is not to be changed and deformed during heating and the subsequent stretch blow molding process, but rather to remain unaltered and maintain its size and shape throughout all processing stages.

An advantageous variant of the method according to the invention allows for the preforms to be heated to the base temperature in the section of the first heating stage by means of inserting heating elements into the open-topped preforms. These heating elements function as so-called boosters in that they require only a very short time for bringing the respective preform from storage temperature to the desired base temperature, which is brought to a yet higher temperature level in the subsequent heating stage by means of applying a temperature profile. This booster or heating element may be of a typical length that corresponds to an individual radiant heater, thus making a largely homogeneous heating of the preforms possible. Moreover, it is also possible for further radiators to function as components of this booster, with said components applying heat radiation to the outside of the preforms for achieving the desired basic heating. Another advantageous variant of the invention is to utilize part of an oven's exhaust heat, which would otherwise be conducted outside, for producing the energy for the basic heating. The oven's exhaust heat can be taken advantage of by, for instance, deflecting the warm exhaust air and/or conducting this exhaust air through suitable heat exchangers for cooling it, thus representing a potential for energy saving.

As already mentioned, the second heating stage essentially serves to apply a temperature profile to the preforms in this temperature profiling phase, with said temperature profile being adjusted and/or varying along the length of said preforms. In order for the preform's thread section to maintain dimensional stability throughout the subsequent process steps, special attention should be paid not to apply too much heat to the thread section when heating the neck section and the remaining preform. As the thread section and the so-called neck ring are required for handling and transport purposes, it is important not to modify these sections of the preform. In the section of the second heating stage, the preforms can be heated in particular by means of radiant heating devices. In order to avoid overheating, said radiant heating devices may be provided with a regulated surface cooling system, if required.

The method regulated in compliance with the configuration according to the invention allows the controlled variables, i.e. the heat output of the first heating stage, to be adjusted very quickly, because the input variable to be considered for temperature regulation is the measured value from the temperature reading immediately after the first heating stage. In contrast to the already known measurement methods, the regulation in this process is already performed after about half of the heating line, thus preventing the controlled variables from deviating too much. This results in more accuracy for the temperature regulation, thus improving, in an effective manner, procedure quality and reducing the scrap rate resulting from improperly formed preforms. In the second heating stage temperature layering is preferably applied under constant conditions, which also prevents the process parameters from drifting and contributes to maintaining a constant quality. The described heating system of the basic heating stage with the optionally employable boosters or heating elements can be operated in a particularly energy-efficient manner, as it allows the preforms to be brought to the required process temperature very quickly.

A further advantage lies in fact that the processes and process parameters can be implemented in the machinery without restrictions, whereby there are no limitations whatsoever with regard to transferability to machinery of the same or a similar kind, even if the said machinery may have respectively different configurations. Furthermore, all conceivable influences connected with the installation or location of the machinery are eliminated as far as possible, thus accelerating time to machinery startup. Such a location factor may also be, for instance, an ambient parameter such as a typical hall temperature that can perceptibly influence the heating process of the preforms.

The present invention also provides a heating device for controlling the temperature of preforms made from a thermoplastic material for a subsequent blow molding or stretch blow molding process. The heating device according to the invention comprises at least two distinct and respectively consecutive heating stages, whereby at least the first heating stage is provided with a heating device for the largely uniform basic heating of the preforms. A further embodiment variant of the heating device according to the invention can intend for at least the first heating stage to be formed by at least one heating element that is inserted into the preforms so that the preforms are heated and brought to the base temperature from inside.

Furthermore, it is possible to provide at least one temperature sensor, which is disposed downstream of the first and upstream of the second heating stage and which is coupled via signal transmission to a control unit for regulating the heat output of the first heating stage with the result that the first heating stage can be regulated very quickly. It is moreover possible for a further temperature sensor to be disposed at the exit of the second heating stage and coupled to a control unit. This helps to further improve the control quality. Other aspects, embodiment variants, and advantages in the configuration and operation of the heating device according to the invention are to be seen in the context of the method variants already mentioned above, as all the method variants are to be regarded as options for operating the heating device.

Furthermore, it must be pointed out here that the present invention is generally suited for use in microwave ovens, rotary ovens, linear ovens, stationary ovens, etc. It is furthermore possible to use individual heating jackets, whereby each preform is selectively temperature-controlled in a separate heating jacket. For purposes of completeness, it should be noted that in addition to the two mentioned, separate heating stages, it is possible to provide further heating stages, as the case may be, without requiring a detailed explanation here.

### BRIEF DESCRIPTION OF THE DRAWINGS

In the following passages, the attached figures further illustrate exemplary embodiments of the invention and their advantages. The size ratios of the individual elements in the figures do not necessarily reflect the real size ratios. It is to be understood that in some instances various aspects of the invention may be shown exaggerated or enlarged to facilitate an understanding of the invention.

The diagram in FIG. 1 shows the connections between strain and the resulting material stress when deforming PET material.

Another diagram in FIG. 2 shows a temperature profile by means of which a respectively different level of heating is applied to the preform in different sections each.

FIG. 3 shows a schematic block diagram in a two-stage heating device that is connected into a control loop.

FIG. 4 shows a schematic illustration of a container forming device for shaping containers for liquids from preforms by means of stretch blow forming.

FIG. 5 shows a heating line according to FIG. 4 in a schematic illustration.

FIG. 6 shows a schematic view of a preferred embodiment variant of the container forming device according to FIG. 4.

FIG. 7 shows a further variant of a container forming device with an additional preheating process.

FIG. 8 shows a detailed view of the booster or the first heating stage.

### DETAILED DESCRIPTION

The same or equivalent elements of the invention are designated by identical reference characters. Furthermore and for the sake of clarity, only the reference characters relevant for describing the respective figure are provided. It should be understood that the detailed description and specific examples of the device and method according to the invention, while indicating preferred embodiments, are intended for purposes of illustration only and are not intended to limit the scope of the invention.

The qualitative diagram given in FIG. 1 illustrates the connections between strain and the resulting material stress when deforming PET material as it is used for stretch blow molded beverage containers. Here, the strain is plotted on the horizontal axis, and the resulting material stress is plotted on the vertical axis. The graphs are to be regarded as exemplary. They illustrate the nearly linearly rising curves for stress under initially low strain, the said curves then flattening along a further section, so that even under increasing material strain nearly no increase results in the stress to the material. The stress curves rise comparatively strongly at a certain limit strain value and at the end of the curves the strain finally causes the material to tear. As is illustrated by the three curves, which are to be regarded as examples, it is possible to improve the stability properties of the plastic bodies by slightly decreasing the forming temperature, because lower temperatures and constant strain will each result in lower material stress.

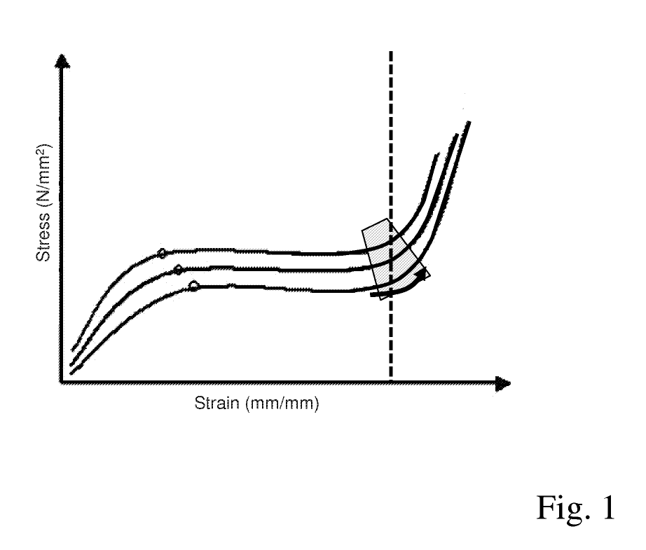

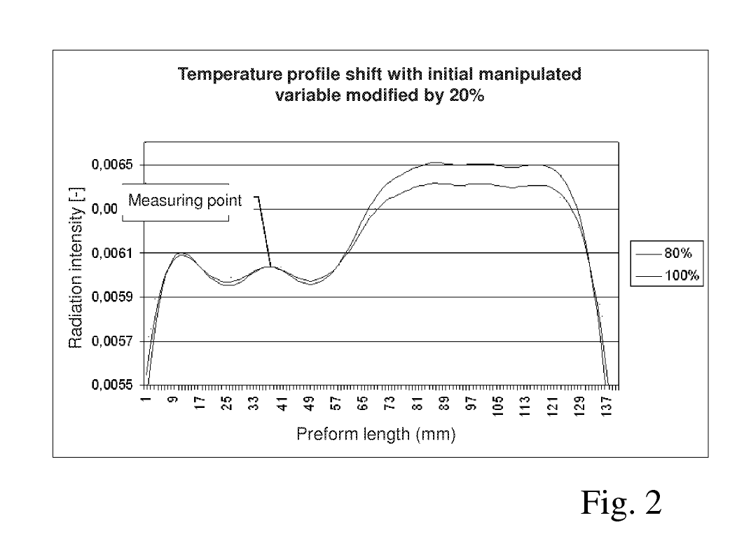

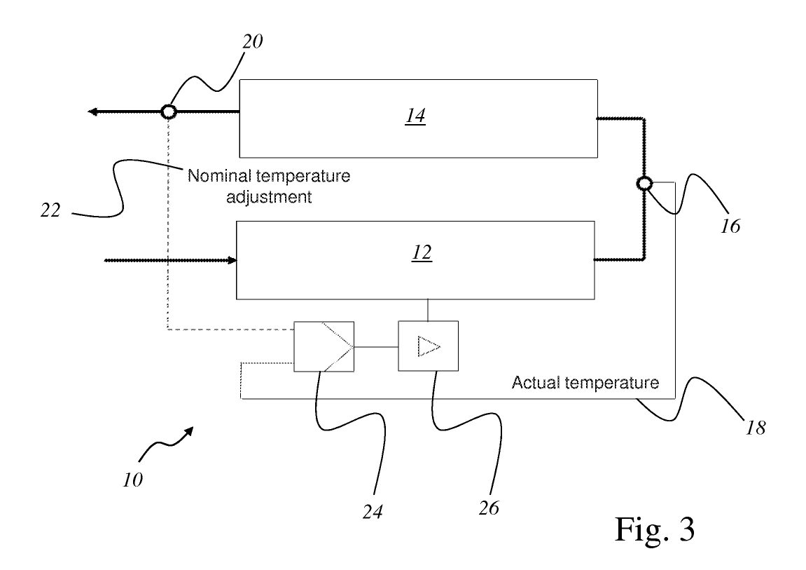

Another diagram in FIG. 2 illustrates a temperature profile by means of which a respectively different level of heating is applied to the preform in different sections each. Thus, the typical length of a preform of approximately 137 mm (“preform length”) is plotted on the horizontal diagram axis, and the dimensionless radiation intensity is plotted on the vertical axis. The diagram illustrates that radiation intensity is, on the one hand, distinctly reduced in the top section up to a preform length of approximately 60 mm, and, on the other hand, increased in the bottom section that is remote from the thread. From the exemplarily plotted curves and from the distinct distance between them it is discernible that a regulation system for a second heating stage, which is intended for applying a desired temperature profile by means of evaluating and factoring in a measurement signal from a temperature sensor disposed in the preform's neck or thread section, may lead to significant deviations of the entire heating profile. As the entire process and product quality may suffer from these deviations, the invention provides an improved regulation system for the basic heating phase in the first heating stage, which will be explained in more detail in following the descriptions for FIG. 3.

The schematic block diagram in FIG. 3 shows a two-stage heating device 10, which is connected into a control loop, whereby said heating device 10 serves for controlling the temperature of preforms made from a thermoplastic material for a subsequent blow molding or stretch blow molding process. The heating device 10, which is connected into a control loop, comprises two separate, consecutive heating stages 12 and 14, whereby the preforms in the first heating stage 12 are brought to a nearly uniform base temperature across their entire volume or their entire dimension, with said base temperature corresponding approximately to a maximum heating temperature for maintaining the dimensional stability of the thread section at the preform's open-topped neck section. The second heating stage 14 can, in contrast, be intended for achieving an unevenly distributed softening temperature, with the heating process according to a predefineable thermal profile and with said softening temperature being the temperature required for blow molding or stretch blow molding at least the preform's body section located below the thread section and/or a collar area located therebelow.

In order to enable the heating device 10 to be regulated, a first temperature sensor 16 is provided for recording an actual temperature 18 at the exit of the first heating stage 12 so that the preforms' temperature after their first basic heating can be recorded. To compensate temperature variations the second heating stage 14 can be adjusted accordingly. The output signal of the first temperature sensor 16 provides a value for the actual temperature 18. It is moreover possible to include a second temperature sensor 20 downstream of the second heating stage 14 for a further temperature reading, which serves to record the final temperature of the preforms after the temperature profiling phase in the second heating stage 14. The value measured by means of the optional second temperature sensor 20 for a nominal temperature 22 can—if such an evaluation is desired—be processed together with the actual temperature 18 provided by the first temperature sensor 16. In order to control the second heating stage 14, the recorded temperature values are processed in a summing circuit 24 and an amplifying stage 26 arranged downstream of the summing circuit 24.

In this way a very fast reacting control system for the control and regulation of an oven can be realized. Because of the favorable placement of the two temperature sensors 16 and 20 strong variations of the heating temperature in the two heating stages 12 and 14 can be avoided reliably.

Due to the advantageous positioning of the two temperature sensors 16 and 20, it is possible, in the described manner, to implement a regulating system for controlling the oven that reacts very quickly and reliably prevents the heating temperatures of both heating stages 12 and 14 from deviating too much.

In the section of the first heating stage 12, or the basic heating phase, the preforms can be heated to a largely uniform base temperature ranging between approximately 50° C. and approximately 90° C. This temperature must at least be below the flow or softening temperature of the thermoplastic material used for the preforms, because in particular the thread section is required to retain its dimensional stability during the temperature control phase in the first heating stage 12, which provides no thermal shielding or cooling for the neck and thread section, in contrast to the second heating stage 14 that commonly does provide such shielding or cooling. It is possible to heat the preforms to the base temperature in the section of the first heating stage 12 by means of, for instance, inserting heating elements into the open-topped preforms. Subsequently, a temperature profile is applied to the preforms in the section of the second heating stage 14, with said temperature profile being adjusted and/or varying along the length of said preforms, this being achieved, for instance, by radiator rails with varying radiation from varying heights, thus producing an appropriately adapted infrared radiation.

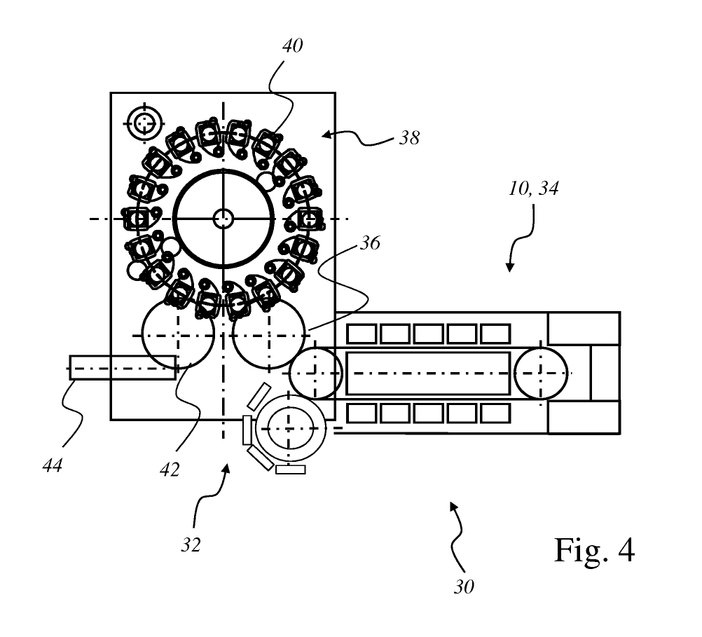

The schematic illustration of FIG. 4 shows a container forming device 30 for shaping containers for liquids from preforms by means of stretch blow forming. The container forming device 30 comprises a rotating entry area 32 for the preforms, a heating line 34 with a regulated two-stage heating device 10 according to FIG. 3 for the temperature control of the preforms and a subsequent adjacent first transfer star 36 for conveying the temperature-controlled preforms to a rotating stretch blow molding device 38. This rotating stretch blow molding device 38 comprises a plurality of blow molding stations 40, where the preforms are formed to make containers for liquids, before they are transferred by means of a second transfer star 42 to a linear conveying device 44, which is used for conveying the containers, in particular to a filling station.

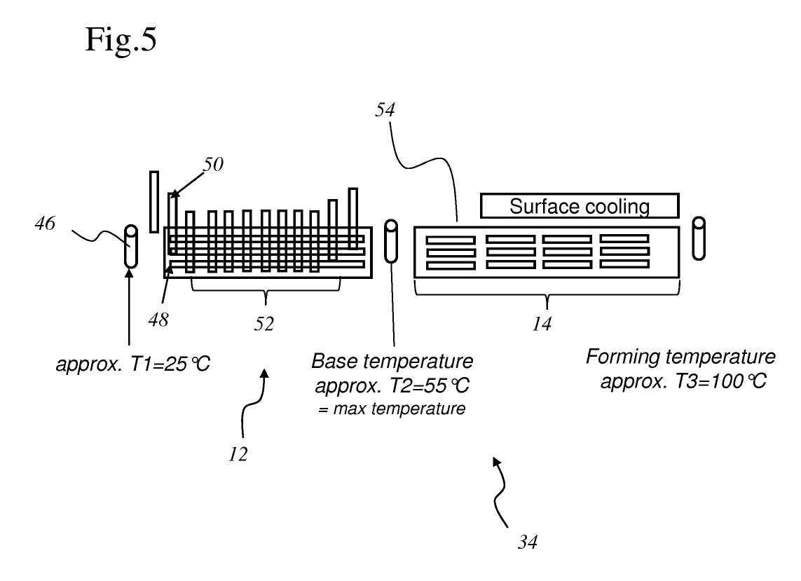

The schematic illustration in FIG. 5 schematically represents a heating line 34 according to FIG. 4, whereby said heating line 34 is part of the heating device 10 according to FIG. 3. In the heating line 34 in FIG. 5, the initially relatively cold preforms 46 that may have, for instance, a temperature T1 of approximately 25° C., are preheated in the first heating stage 12 (cf. FIG. 3) to a base temperature T2 of approximately 55° C. In the present exemplary embodiment, this base temperature T2 corresponds to the maximum thread temperature that the preforms 46 may be exposed to without deforming the thread section. The first heating section 12 can optionally comprise a radiator section 48 with infrared radiators and/or additional heating elements 50, which can be individually inserted into the preforms 46 for quick and precise heating of said preforms 46. Both heating devices 48 and 50 can optionally be combined with each other, with the result that the first heating stage 12 will act as a booster 52 for bringing the preforms 46 quickly and precisely to the desired base temperature T2 (here: approximately 55° C.).

The subsequent adjacent second heating stage 14 also comprises a radiator section 54 with infrared radiators, which are, however, variably regulated in order to create the desired temperature profile, with the result that, on the one hand, the necessary forming temperature T3 of approximately 100° C. is achieved, but, on the other hand, the thread section of the preforms 46 is kept at the temperature level of T2. As already described in relation to FIG. 3, the heating of at least the second heating stage 14 to the desired temperature T3 is controlled on the basis of the evaluation of the signals 18 from temperature senor 16 arranged between the two heating stages 12 and 14.

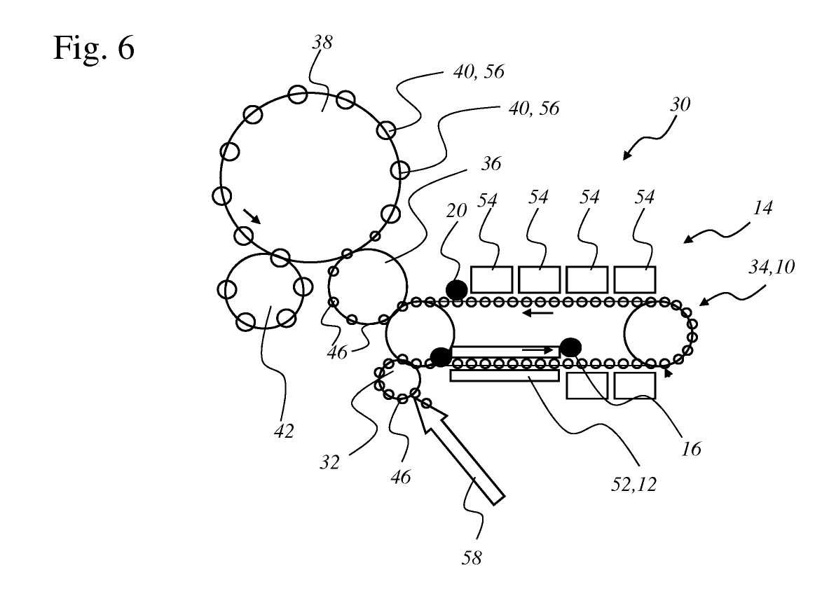

The illustration in FIG. 6 shows a schematic view of a preferred embodiment variant of the container forming device according to FIG. 4. Again, the container forming device 30 with the rotating entry area 32 for the preforms, the heating line 34 with the regulated two-stage heating device 10 according to FIG. 3 for the temperature control of the preforms, and the subsequent adjacent rotary first transfer star 36 for conveying the temperature-controlled preforms to the rotating stretch blow molding device 38 are illustrated here. In this rotating stretch blow molding device 38, the preforms 46 are formed to make containers for liquids 56 by means of blow molding stations 40 located at the outer circumference, before they are transferred to the conveying device 44 by means of the second transfer star 42, which conveys the containers 56 to the filling station or any other handling station (not illustrated here).

Just behind the entry area 32 the heating line 34 comprises the booster 52 or the first heating stage 12 for the basic heating of the preforms 46. Downstream of the booster 52 are the radiator areas 54 of the second heating stage 14, which is indicated in the presented exemplary embodiment by altogether six consecutively arranged heating boxes. Upstream of the rotating entry area 32 with the entry star wheel is a linear feed path 58 for feeding the preforms 46 to the container forming device 30.

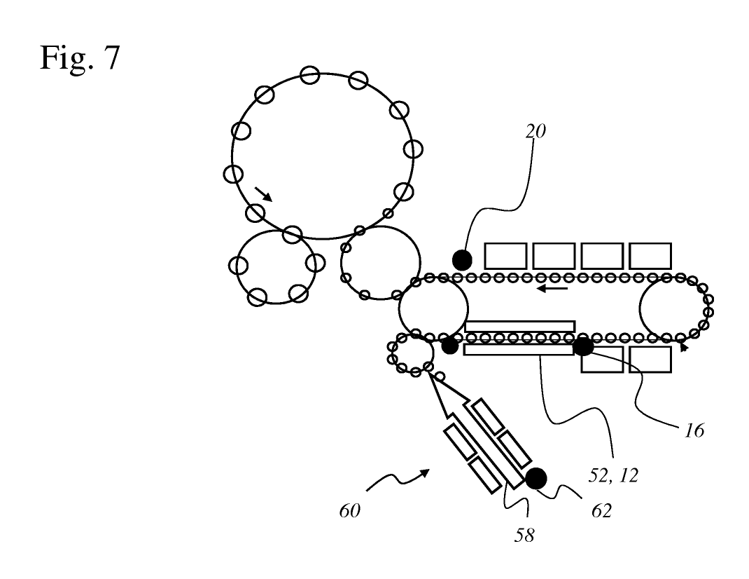

According to FIG. 7, it is possible to equip this linear feed path 58 with an additional preheating device 60, which may be supplied, for instance, with exhaust heat from the heating device 10 or the like, thus allowing the utilization of a considerable amount of thermal energy, which would otherwise be discharged without being used, for preheating the preforms, and contributing in this way to the efficiency increase of the temperature control process. The rest of the construction of device 30 is the same as in the embodiment variant according to FIG. 6.

Both variants according to FIG. 6 and FIG. 7 have the temperature measurement points in common, which are schematically indicated. The first temperature sensor 16 is thus located immediately downstream of the first heating stage 12 or the booster 52. The second temperature sensor 20 is located downstream of the second heating stage 14, i.e. downstream of the last heating box with the radiator sections 54 arranged therein, as is illustrated in the FIGS. 6 and 7, respectively. According to FIG. 7, there can optionally be a third temperature sensor 62 in the linear feed path 58 and the preheating device 60 or located upstream of these sections, as illustrated in FIG. 7. The output signal of the said third temperature sensor 62 can by preference additionally be taken into account in the control loop of the heating device 10 (cf. FIG. 3).

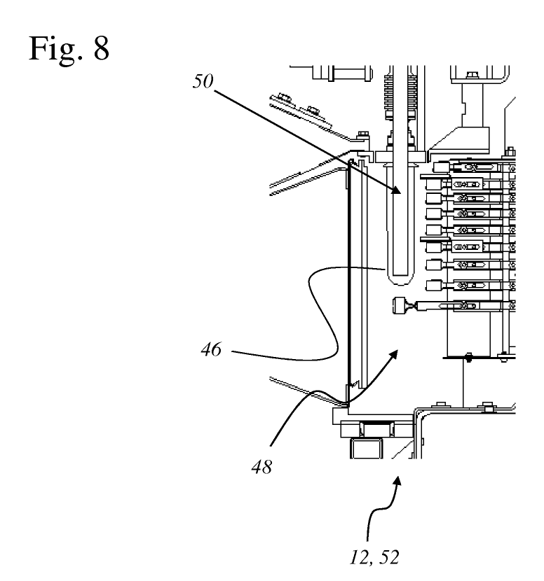

The detailed view in FIG. 8 illustrates an embodiment variant of the first heating stage 12 or the booster 52. According to FIG. 5, it is thereby possible to allow for the preform 46 to be heated to the base temperature T2 of approximately 55° C. by means of the heating element 50 being completely inserted into the said preform 46 and/or by means of the infrared radiators in the radiator section 48. The radiators of radiator section 48 can preferably be provided with a suitable cooling system in order to avoid overheating of the radiators in the heating oven 10 by circulating cooling air.

The invention has been described with reference to a preferred embodiment. Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

### LIST OF REFERENCE CHARACTERS

10 Heating device
12 First heating stage
14 Second heating stage
16 First temperature sensor
18 Actual temperature
20 Second temperature sensor
22 Nominal temperature
24 Summing circuit
26 Amplifying stage
30 Container forming device
32 Entry area
34 Heating line
36 First transfer star
38 Stretch blow molding device
40 Blow molding station
42 Second transfer star
44 Conveying device
46 Preform
48 Radiator area
50 Heating element
52 Booster
54 Radiator area
56 Container for liquids
58 Linear feed path
60 Preheating device
62 Third temperature sensor

What is claimed is:

1. A method for the temperature control and/or regulation of a heating device for preforms made from a thermoplastic material, for controlling the temperature of said preforms prior to a subsequent blow molding or stretch blow molding process, the method comprising the steps of:
passing the preforms through a temperature control process comprising at least a first heating stage and a distinct, consecutive second heating stage, an entirety of the preforms being heated to a near uniform base temperature in the first heating stage;
taking at least one temperature reading of the preforms after the first heating stage;
determining deviations of the at least one temperature reading from a specified set point temperature, a first temperature reading of the at least one temperature reading being taken after the first heating stage;
regulating and/or adjusting radiators in the second heating stage as a function of the first temperature reading; and
compensating for the temperature deviations of the preforms from the specified set point temperature prior to exit of the preforms from the heating device.

2. The method as recited in claim 1 wherein the temperatures of radiators in the first heating stage and the radiators in the second heating stage are regulated simultaneously on the basis of the at least one temperature reading.

3. The method as recited in claim 1 wherein the at least one temperature reading includes a plurality of temperature readings taken at several positions along a longitudinal axis of the preforms and whereby the radiators of the second heating stage are respectively regulated in associated preform heights.

4. The method as recited in claim 1 wherein the at least one temperature reading is taken in a section of an infrared oven with a change of direction.

5. The method as recited in claim 4 wherein the at least one temperature reading is taken in a turnaround section of a linear infrared oven.

6. The method as recited in claim 1 wherein the regulating or adjusting of the radiators in the second heating stage is a function of an average preform temperature calculated from several temperature readings of the at least one temperature reading taken from successive preforms.

7. The method as recited in claim 1 wherein an approximately uniform base temperature of the entirety of the preform is achieved in the first heating stage, the base temperature corresponding at the most to a maximum heating temperature for maintaining dimensional stability of a thread section at an open-topped neck section of the preform.

8. The method as recited in claim 7 wherein the at least one temperature reading is provided at the exit of the first heating stage for recording a basic temperature of the preform after the first heating stage and for simultaneous adjustment of the first heating stage and the second heating stage.

9. The method as recited in claim 1 wherein the preforms are heated in a section of the first heating stage to a uniform base temperature ranging between approximately 50° C. and approximately 90° C.

10. A heating device for the temperature control of preforms made from a thermoplastic material for a subsequent blow molding or stretch blow molding process, the heating device comprising:
a first heating stage; and
a distinct, consecutive second heating stage;
the first heating stage comprising a heating device for bringing the preforms to an approximately uniform base temperature; and
at least one first temperature sensor arranged downstream of the first heating stage and upstream of the second heating stage, the first temperature sensor being coupled via signal transmission to a control unit for regulating a heat output of the second heating stage.

11. The heating device as recited in claim 10 wherein the at least one first temperature sensor is arranged downstream of the first heating stage and upstream of the second heating stage with the first temperature sensor being coupled via signal transmission to the control unit for jointly regulating the heat output of second heating stage and a heat output of the first stage.

12. The heating device as recited in claim 10 further comprising a further temperature sensor arranged at an exit of the second heating stage, the further temperature sensor being coupled to the control unit.
